(19) United States
(12) Patent Application Publication
(10) Pub. No.: US 2026/0246891 A1
(43) Pub. Date: Aug. 20, 2026

(54) ELECTRONIC APPARATUS AND CONTROL METHOD THEREOF

(71) Applicant: SAMSUNG ELECTRONICS CO., LTD., Suwon-si (KR)

(72) Inventors: Taekyung Yoon, Suwon-si (KR); Eungsik Yoon, Suwon-si (KR); Kwangsun Baek, Suwon-si (KR)

(73) Assignee: SAMSUNG ELECTRONICS CO., LTD., Suwon-si (KR)

(21) Appl. No.: 19/642,315

(22) Filed: Apr. 8, 2026

Related U.S. Application Data
(63) Continuation of application No. PCT/KR2025/020195, filed on Nov. 28, 2025.

(30) Foreign Application Priority Data
Dec. 5, 2024 (KR) 10-2024-0179720

(51) Int. Cl. H04N 1/60; G06V 20/40; H04N 19/186

(52) U.S. Cl. CPC H04N 1/6058; G06V 20/49; H04N 1/6008; H04N 19/186

(57) ABSTRACT

An electronic apparatus includes, memory storing at least one instruction; a communication interface; a display; and at least one processor, wherein the at least one instruction, when executed by the at least one processor, individually or collectively, causes the electronic apparatus to acquire sub-videos by segmenting a first video received through the communication interface, acquire second video data by performing gamut mapping on first partial video data corresponding to the sub-videos to map the first partial video data to a second gamut different from a first gamut corresponding to the first video, wherein a size of the second video data is less than a size of the first partial video data, and control the display to display a second video corresponding to the first video based on the second video data.

### CROSS-REFERENCE TO RELATED APPLICATIONS

This application is a Continuation Application of International Application PCT/KR2025/020195 filed on November 28, 2025, at the Korean Receiving Office, which claims benefit of Korean Patent Application No.10-2024-0179720, filed on December 5, 2024, at the Korean Intellectual Property Office, the disclosures of which are incorporated herein in their entireties by reference.

### FIELD

Apparatuses and methods consistent with the disclosure relate to an electronic device and a control method thereof, and more particularly, to an electronic device for acquiring video data by decoding and gamut-mapping each segmented video, and a control method thereof.

### BACKGROUND

With the development of an electronic technology, various kinds of display apparatuses have been developed. In particular, recently, display apparatuses equipped with various types of displays have been popularized, thereby improving user convenience.

For example, recently, display apparatuses equipped with an ePaper display have been popularized. Since the ePaper display consumes less power, the display apparatus has been widely used in situations where the display apparatus is not connected to an external power supply.

In addition, since the ePaper mainly displays simple black and white or low-color images, original video data should be mapped to low-color image data.

### SUMMARY

According to an aspect of the disclosure, an electronic apparatus includes, memory storing at least one instruction; a communication interface; a display; and at least one processor, wherein the at least one instruction, when executed by the at least one processor, individually or collectively, may cause the electronic apparatus to acquire a plurality of sub-videos by segmenting a first video received through the communication interface, acquire second video data by performing gamut mapping on first partial video data corresponding to the plurality of sub-videos to map the first partial video data to a second gamut different from a first gamut corresponding to the first video, wherein a size of the second video data is less than a size of the first partial video data, and control the display to display a second video corresponding to the first video based on the second video data.

The at least one instruction, when executed by the at least one processor, individually or collectively, may cause the electronic apparatus to acquire the plurality of sub-videos by segmenting the first video such that the plurality of sub-videos have a same size and a same resolution.

The at least one instruction, when executed by the at least one processor, individually or collectively, may cause the electronic apparatus to acquire second partial video data by performing gamut mapping on the first partial video data, and to acquire the second video data based on the second partial video data.

The at least one instruction, when executed by the at least one processor, individually or collectively, may cause the electronic apparatus to acquire the first partial video data by decoding the plurality of sub-videos, and to acquire the second partial video data by performing gamut mapping on the first partial video data.

A second color depth of the second gamut may be lower than a first color depth of the first gamut, for a plurality of pixels in the plurality of sub-videos.

The first partial video data may include, for the plurality of pixels, a first plurality of color values including red (R), green (G), blue (B) values, wherein the first plurality of color values respectively includes a first number of bits corresponding to the first color depth, and wherein a second plurality of color values of the second partial video data respectively includes a second number of bits corresponding to the second color depth, the second number of bits being less than the first number of bits.

The first plurality of color values may respectively include 8 bits, the second plurality of color values may include, for the plurality of pixels, R, yellow (Y), B, and white (W) values, and the second gamut may include 6 colors, the 6 colors being based on the R, Y, B, and W values.

The at least one instruction, when executed by the at least one processor, individually or collectively, may cause the electronic apparatus to sequentially perform gamut mapping on the first partial video data based on spatial locations of the plurality of sub-videos.

The at least one instruction, when executed by the at least one processor, individually or collectively, may cause the electronic apparatus to acquire, based on postprocessing the second video data for improved image quality, third video data having a size less than the size of the first partial video data, and control the display to display a third video corresponding to the third video data.

The at least one instruction, when executed by the at least one processor, individually or collectively, may cause the electronic apparatus to acquire the second video data by performing gamut mapping on the first partial video data based on a block mode in which the first video is segmented into a plurality of pieces, and receive a user manipulation input, through the communication interface, for switching from the block mode to a full mode, based on the user manipulation input being received, acquire fourth video data by decoding the first video, and acquire the second video data by performing gamut mapping on the fourth video data.

According to an aspect of the disclosure, a control method of an electronic apparatus includes acquiring a plurality of sub-videos by segmenting a first video received through a communication interface; acquiring second video data by performing gamut mapping on first partial video data corresponding to the plurality of sub-videos to map the first partial video data to a second gamut different from a first gamut corresponding to the first video, wherein a size of the second video data is less than a size of the first partial video data; and displaying a second video corresponding to the first video based on the second video data.

The acquiring the plurality of sub-videos may include acquiring the plurality of sub-videos by segmenting the first video such that the plurality of sub-videos have a same size and a same resolution.

The acquiring the second video data may include acquiring second partial video data by performing gamut mapping on the first partial video data, and acquiring the second video data based on the second partial video data.

The acquiring the second partial video data may include acquiring the first partial video data by decoding the plurality of sub-videos, and acquiring the second partial video data by performing gamut mapping on the first partial video data.

A second color depth of the second gamut may be lower than a first color depth of the first gamut, for a plurality of pixels in the plurality of sub-videos.

The first partial video data may include, for the plurality of pixels, a first plurality of color values including red (R), green (G), blue (B) values, wherein the first plurality of color values respectively includes a first number of bits corresponding to the first color depth, and wherein a second plurality of color values of the second partial video data respectively includes a second number of bits corresponding to the second color, the second number of bits being less than the first number of bits.

The first plurality of color values may respectively include 8 bits, the second plurality of color values may include, for the plurality of pixels, R, yellow (Y), B, and white (W) values, and the second gamut may include 6 colors, the 6 colors being based on the R, Y, B, and W values.

The performing the gamut mapping may include sequentially performing gamut mapping on the first partial video data based on spatial locations of the plurality of sub-videos.

The control method may further include acquiring, based on postprocessing the second video data for improved image quality, third video data having a size less than the size of the first partial video data; and displaying a third video corresponding to the third video data.

According to an aspect of the disclosure, a non-transitory computer-readable storage medium having at least one instruction recorded thereon, that, when executed by at least one processor, individually or collectively, may cause the at least one processor to acquire a plurality of sub-videos by segmenting a first video received through a communication interface; acquire second video data by performing gamut mapping on first partial video data corresponding to the plurality of sub-videos to map the first partial video data to a second gamut different from a first gamut corresponding to the first video, wherein a size of the second video data is less than a size of the first partial video data; and display a second video corresponding to the first video based on the second video data.

### BRIEF DESCRIPTION OF DRAWINGS

The above and other aspects, features, and advantages of certain embodiments of the present disclosure are more apparent from the following description taken in conjunction with the accompanying drawings, in which:

FIG. 1 is a diagram for schematically describing an operation of an electronic apparatus according to one or more embodiments of the present disclosure.

FIG. 2 is a block diagram for describing a configuration of an electronic apparatus according to one or more embodiments of the present disclosure.

FIG. 3 is a diagram for describing a detailed configuration of the electronic apparatus according to one or more embodiments of the present disclosure.

FIG. 4 is a flowchart for describing the detailed configuration of the electronic apparatus according to one or more embodiments of the present disclosure.

FIG. 5 is a diagram for describing a block decoding operation according to one or more embodiments of the present disclosure.

FIG. 6 is a diagram for describing gamut mapping according to one or more embodiments of the present disclosure.

FIG. 7 is a diagram for describing a memory budget according to one or more embodiments of the present disclosure.

FIG. 8 is a diagram for describing the memory budget according to one or more embodiments of the present disclosure.

FIG. 9 is a diagram for describing a block mode and a full mode according to one or more embodiments of the present disclosure.

FIG. 10 is a flowchart for describing a control method of an electronic apparatus according to one or more embodiments of the present disclosure.

### DETAILED DESCRIPTION

Since the present disclosure may be variously modified and have several exemplary embodiments, specific exemplary embodiments of the present disclosure will be illustrated in the drawings and be described in detail in the detailed description. However, it is to be understood that the disclosure are not limited to specific exemplary embodiments, but include all modifications, equivalents, and substitutions according to exemplary embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope and spirit of the disclosure are not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular expressions are intended to include plural expressions unless the context clearly indicates otherwise.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

In the disclosure, an expression “A or B,” at least one of “A or/and B,” “one or more of A or/B,” or the like, may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

Expressions “first”, “second”, “1st,” “2nd,” or the like, used in the disclosure may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

On the other hand, when it is mentioned that any component (for example, a first component) is “directly coupled” or “directly connected” to another component (for example, a second component), it is to be understood that the other component (for example, a third component) is not present between any component and another component.

An expression “~configured (or set) to” used in the disclosure may be replaced by an expression “suitable for,” “having the capacity to,” “~designed to,” “~adapted to,” “~made to,” or “~capable of” depending on a situation. A term “~configured (or set) to” may not necessarily mean “specifically designed to” in hardware.

Instead, an expression “~an apparatus configured to” may mean that the apparatus “is capable of” together with other apparatuses or components. For example, a “processor configured (or set) to perform A, B, and C” may mean a dedicated processor (for example, an embedded processor) for performing the corresponding operations, a processor such as a central processing unit (CPU), or an application processor) that may perform the corresponding operations by executing one or more software programs stored in a memory apparatus.

In exemplary embodiments, a “module” or a “unit” may perform at least one function or operation, and be implemented by hardware or software or be implemented by a combination of hardware and software. In addition, a plurality of “modules” or a plurality of “~ers/ors” may be integrated in at least one module and be implemented by at least one processor except for a ‘module’ or an ‘~er/or’ that needs to be implemented by specific hardware.

Meanwhile, various elements and regions in the drawings are schematically illustrated. Therefore, the spirit of the present disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

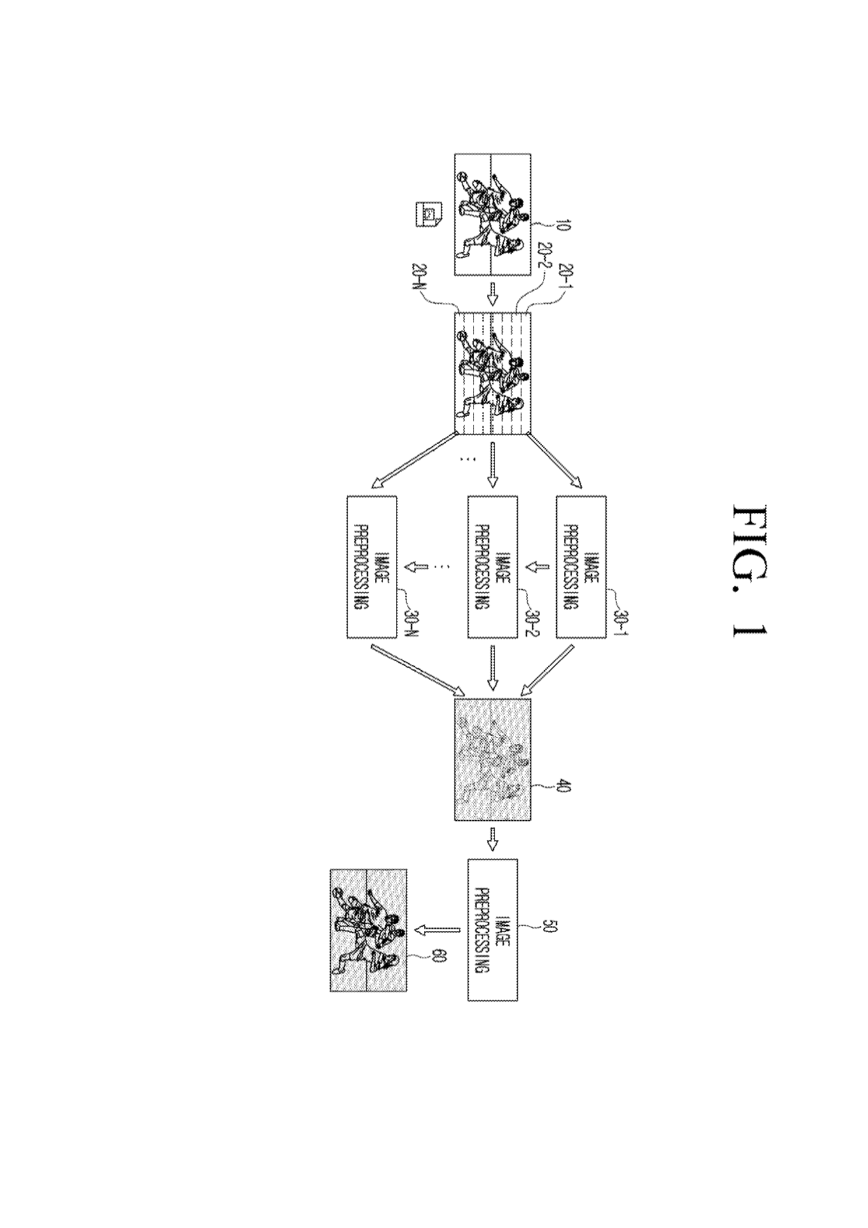

FIG. 1 is a diagram for schematically describing an operation of an electronic apparatus according to one or more embodiments of the present disclosure.

Referring to FIG. 1, an original video 10 (or first video), a plurality of sub-videos 20-1, 20-2, ..., 20-N, an intermediate video 40 (or second video), and a final video 60 (or third video) are illustrated.

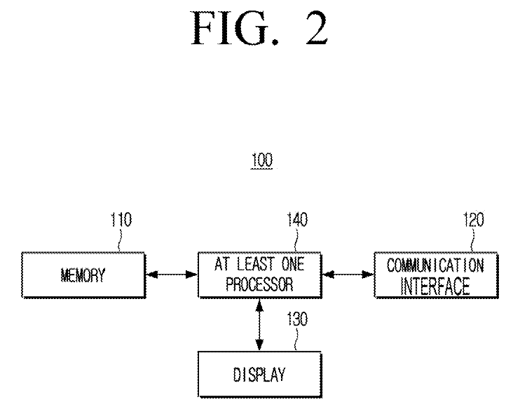

The electronic apparatus may receive the original video 10 and acquire the final video 60 corresponding to the original video 10. Here, the electronic apparatus may be implemented as an apparatus capable of performing a video processing function, such as a PC or a set-top box, and the electronic apparatus will be described in detail with reference to FIG. 2.

Here, the video may correspond to visual information stored in a digital format. Here, the visual information may include color and brightness information for each pixel and may be displayed on a screen. For example, the video may correspond to a photo captured with a digital camera or a graphic generated by a computer. However, the video is not limited thereto.

Here, the original video 10 may refer to a video displayed on the screen based on video information that has not been edited or postprocessed 50. Here, the editing or postprocessing 50 may refer to a process of applying modification or improvement task to an image to generate a final result that is different from the original. Here, the video information may correspond to data for the visual expression of an image, including data such as pixels, colors, and resolutions.

For example, the original video 10 may correspond to a result interpreted from data stored in an original video file illustrated below the original video 10. Here, the result may be displayed on the screen based on pixel values and color information stored in the file.

The original video file may refer to a file that was initially saved after the video was captured or produced. Here, the file may correspond to a file in a state in which compression has been applied. For example, the file may correspond to joint photographic experts group (JPEG) (or JPG), portable network graphics (PNG), graphics interchange format (GIF), or bitmap image files (BMP) that were directly saved from the camera. However, the file is not limited thereto.

Here, compressing a video may correspond to a process of encoding data to reduce a size of an image. For example, lossy compression may correspond to a compression method that allows some data loss and may reduce the size. For example, lossless compression may correspond to a compression method that reduces the size without data loss. However, the method of compressing a video is not limited thereto.

Meanwhile, a video processing process may be performed on the original video 10 according to the characteristics of the electronic apparatus for displaying the original video 10. The original video 10 may be converted into the final video 60 through the video processing process.

Here, the video processing process may refer to the overall process of receiving a compressed video file from an electronic apparatus, decoding the compressed video file, interpreting image data, and displaying the image data on a screen. For example, the electronic apparatus may receive a compressed JPG file, decode the compressed JPG file, interpret the image data, and display the image data on the screen.

Here, interpreting the image data may refer to decoding the data of the compressed file, extracting the color information of each pixel, and visually reconstructing the extracted color information.

For example, the electronic apparatus may receive a JPG file from an external apparatus such as a server, and decode the JPG file, convert the JPG file into RGB pixel values, and display the image on the screen.

Through this video processing process, the electronic apparatus may generate the intermediate video 40. The intermediate video 40 may refer to a video generated during the video processing process before the initial decoding and post-processing (image postprocessing) 50 are applied. Here, the post-processing may correspond to an additional processing process before the final output, such as image quality improvement and noise removal.

Here, the intermediate video 40 may correspond to a video acquired by performing the preprocessing (image preprocessing) on the original video 10. However, the intermediate video 40 is not limited thereto, and the intermediate video 40 may correspond to a video acquired by segmenting the original video 10 and performing the preprocessing 30-1, 30-2, ..., 30-N on the original video 10.

Here, segmenting the original video 10 may mean segmenting the video file of the first video. Here, N may refer to the number of sub-videos generated by segmenting the original image.

Here, the plurality of sub-videos 20-1, 20-2, ..., 20-N may refer to videos acquired by segmenting the original video 10 into multiple parts. Here, segmenting the original video 10 may refer to segmenting the original video 10 into multiple parts according to a location of each part. For example, the plurality of sub-videos 20-1, 20-2, ..., 20-N may refer to each of the eight videos that make up the original video 10 when the original video 10 is divided horizontally into eight parts. However, the plurality of sub-videos are not limited thereto.

Segmenting the video file of the first video may refer to a task of reading metadata such as the size, resolution, and color information of the image based on header information of the file, and dividing the image into small block units based on the metadata.

Here, the header information may include data necessary for each segmented block to be accurately interpreted and processed.

Meanwhile, the preprocessing may correspond to a process of decoding a compressed image file to restore the original pixel data and perform basic conversion tasks necessary for displaying the compressed image file on the screen. Here, the preprocessing may include color space conversion, resolution adjustment, etc.

For example, the original video 10 may be segmented into a plurality of sub-videos 20-1, 20-2, ..., 20-N. Here, a plurality of image preprocessing 30-1, 30-2, ..., 30-N may be performed on each of the plurality of sub-videos 20-1, 20-2, ..., 20-N.

For example, the first image preprocessing 30-1 may be performed on the first sub-video 20-1 among the plurality of sub-videos, and the second image preprocessing 30-2 may be performed on the second sub-video 20-2. First image preprocessing to Nth image preprocessing 30-1, 30-2, ..., 30-N may each include an image processing process of the same type.

However, the first image preprocessing to the Nth image preprocessing 30-1, 30-2, ..., 30-N may each include a different image processing process according to the corresponding sub-videos 20-1,20-2, ..., 20-N, but are not limited thereto.

Accordingly, when the image preprocessing 30-1, 30-2, ..., 30-N is performed on each of the plurality of sub-videos 20-1, 20-2, ..., 20-N, the intermediate video 40 in which the plurality of preprocessed sub-videos are combined may be generated.

The intermediate video 40 may be converted into the final video 60 through the postprocessing 50. Here, the final video 60 is a video in which both preprocessing (e.g., decoding, color conversion, etc.) 30-1, 30-2, ..., 30-N and postprocessing (e.g., image quality improvement, noise removal, etc.) 50 are completed, and may correspond to a completed video ready to be output on a screen.

The electronic apparatus of the present disclosure may segment the original video 10 in this way and perform the preprocessing 30-1, 30-2, ..., 30-N process on each original video 10 separately. The amount of computation according to this method may be the same as the amount of computation when the original video 10 is preprocessed as it is.

Here, the amount of computation may mean the amount of computation to process the image data. Here, the amount of computation may be determined according to the resolution, the color depth, and the complexity of algorithm.

In order for the electronic apparatus to perform the image processing process (or computation), the memory used for the image resolution, the color depth data, the intermediate processing results of the electronic apparatus, and the postprocessing task may be required. Here, the memory will be described in detail below with reference to FIG. 2.

Here, the maximum memory capacity that the electronic apparatus should allocate for the image processing may be referred to as the memory budget.

When this memory budget is reduced, the required capacity and quantity of memory chips are reduced, and the raw materials and production process required for memory manufacturing may be simplified. Accordingly, the production cost of the memory semiconductor and the cost of the memory-related components in an apparatus may be reduced, thereby lowering the manufacturing cost.

The memory budget may be determined by the memory capacity required to store and process the intermediate video 40 and the final video 60 in the video processing process. Here, the memory capacity may correspond to the capacity required to temporarily store and delete the intermediate data such as the intermediate video 40 or to store new data.

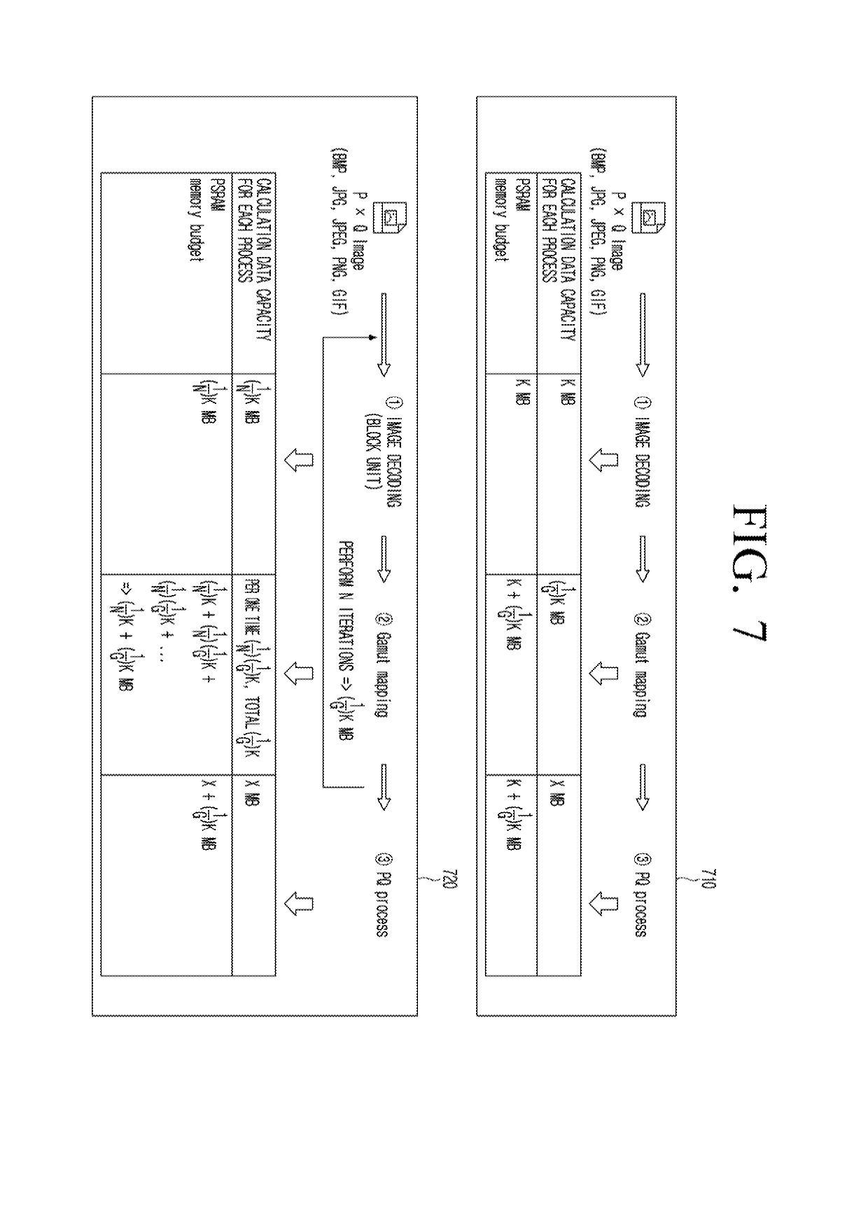

When the electronic apparatus performs the video processing process by segmenting the original video 10 instead of processing the original video 10 as it is, this memory budget may be reduced. In other words, by this method, the memory capacity required for the video processing process may be reduced while the total amount of computation involved in the image processing process may be maintained. This will be described in detail below with reference to FIG. 7, etc.

Operation steps of acquiring, by the electronic apparatus 100, video data will be described in detail below with reference to FIG. 2.

FIG. 2 is a block diagram for describing a configuration of an electronic apparatus according to one or more embodiments of the present disclosure.

Referring to FIG. 2, the electronic apparatus 100 may include a memory 110, a communication interface 120, a display, and at least one processor 140.

The electronic apparatus 100 may process the original video 10 as illustrated in FIG. 1 to acquire the video data corresponding to each of the intermediate video and the final video.

Here, the electronic apparatus 100 may segment the original video 10 and then decode each of the plurality of sub-videos acquired by the segmentation. The electronic apparatus 100 may acquire first partial video data corresponding to each of the plurality of sub-videos. Here, the first partial video data may correspond to data acquired by performing decoding on the plurality of sub-videos acquired by segmentation. This will be described in detail with reference to FIG. 2.

Here, the video data corresponding to the intermediate video may correspond to data that has undergone the preprocessing process and has not been undergone the postprocessing. For example, the video data corresponding to the intermediate video may correspond to data in which basic color conversion or decoding has been completed.

In the present disclosure, the data corresponding to the intermediate video may be referred to as second video data.

In this case, when the electronic apparatus 100 segments and decodes the original video 10, the first partial video data may be processed to acquire second partial video data.

Here, the second partial video data may correspond to data acquired by performing gamut mapping from the first partial video data. The gamut mapping will be described in detail in the following section.

Meanwhile, the video data corresponding to the final video may correspond to data for which both the preprocessing and postprocessing have been completed, and may correspond to completed data that is finally ready to be output on the screen or stored. Here, the video data corresponding to the final video may be referred to as third video data. The same applies hereinafter.

Meanwhile, the electronic apparatus 100 may be implemented as at least one of a smartphone, a tablet personal computer (PC), a desktop PC, a laptop PC, a PC, a set-top box, an over-the-top media service (OTT service) server, a console (video game console), a Blu-ray player, a digital video disc or digital versatile disc (DVD) player, a home automation control panel, a security control panel, a media box (e.g., Samsung HomeSyncTM, AppleTVTM, or Google TVTM), and a game console (e.g., XboxTM, PlayStationTM).

Meanwhile, the electronic apparatus 100 may be implemented as an apparatus capable of performing video processing. Here, the video processing apparatus is an apparatus that processes input video data and converts the input video data into a form to be output, and may perform tasks such as decompression, filtering, and color conversion. The electronic apparatus 100 may be implemented in apparatuses such as the above-described smartphone, tablet, console, and OTT service server.

When the electronic apparatus 100 is implemented as an apparatus with a screen (a smartphone or TV), the electronic apparatus 100 may directly display the processed video. In this case, the electronic apparatus 100 may include a display 130. This will be described in detail in the following section. On the other hand, when the electronic apparatus 100 is implemented as an apparatus without a screen (a server or a media box), the video may be transmitted to an external screen (a display apparatus, etc.) and output. For example, the OTT server may process video data and stream the video data to a user apparatus.

Meanwhile, the electronic apparatus 100 may be implemented as an apparatus that may process input video to display the video on E-paper.

Here, the E-paper may correspond to a low-power display that displays visual information using reflected light like paper. The E-paper may maintain images or text without consuming power. For example, the E-paper may be mainly used in e-book readers, electronic tags, etc.

The E-paper may form an image by moving fine particles using an electric field. Specifically, in the E-paper, bright and dark particles may change their arrangements in each pixel of the screen to form an image. The locations of the particles may be maintained without power consumption even when the power is turned off.

When the electronic apparatus 100 is implemented as an apparatus capable of processing input video to display video on the E-paper, the electronic apparatus 100 may process the input video data into a form suitable for the E-paper.

Here, the electronic apparatus 100 may convert video data to a low resolution and transmit the video data as a signal optimized for E-paper display. For example, the electronic apparatus 100 may perform video processing functions suitable for E-paper characteristics, such as color restriction, brightness adjustment, and screen refresh frequency adjustment. However, the electronic apparatus 100 is not limited thereto.

The memory 110 is electrically connected to at least one processor 140 and may store data for various embodiments of the present disclosure. For example, the memory 110 may be implemented as an internal memory such as a random access memory (RAM) included in the processor 140, or may be implemented as a separate memory from at least one processor 120.

The memory 110 may be implemented in a form of a memory embedded in the electronic apparatus 100 or a form of a memory attachable to and detachable from the electronic apparatus 100, depending on a data storing purpose. For example, data for driving the electronic apparatus 100 may be stored in the memory embedded in the electronic apparatus 100, and data for an extension function of the electronic apparatus 100 may be stored in the memory attachable to and detachable from the electronic apparatus 100. Meanwhile, the memory 110 embedded in the electronic apparatus 100 may include at least one of, for example, a volatile memory (for example, a dynamic random access memory (DRAM), a static RAM (SRAM), a synchronous dynamic RAM (SDRAM), or the like), a non-volatile memory (for example, a one time programmable read only memory (OTPROM), a programmable ROM (PROM), an erasable and programmable ROM (EPROM), an electrically erasable and programmable ROM (EEPROM), a mask ROM, a flash ROM, or the like), a flash memory (for example, a NAND flash, a NOR flash, or the like), a hard drive, and a solid state drive (SSD)).

Meanwhile, in the illustrated example, the electronic apparatus 100 is illustrated as being composed of one memory, but when distinguishing between volatile memory and non-volatile memory, the electronic apparatus (100) may be referred to as including a plurality of memories.

The memory 110 according to one or more embodiments may store at least one instruction. Here, at least one instruction may correspond to at least one command for the electronic apparatus 100 to acquire the second video data, etc. In addition, the memory 110 may store information for the operation of the electronic apparatus 100.

The communication interface 120 is a component performing communication with various types of external apparatuses depending on various types of communication manners. The communication interface 120 may include a wireless fidelity (WiFi) module, a Bluetooth module, an infrared communication module, a wireless communication module, and the like. Here, each communication module may be implemented in the form of at least one hardware chip.

The Wi-Fi module and the Bluetooth module may perform communication in the Wi-Fi method and the Bluetooth method, respectively. In the case of using the Wi-Fi module or the Bluetooth module, various connection information such as a service set identifier (SSID), a session key, and the like, is first transmitted and received, communication is connected using the connection information, and various information may then be transmitted and received.

The infrared communication module performs communication according to an infrared data association (IrDA) technology of wirelessly transmitting data to a short distance using an infrared ray positioned between a visible ray and a millimeter wave.

Wireless communication modules may include at least one communication chip performing communication according to various wireless communication standards such as zigbee, 3rd generation (3G), 3rd generation partnership project (3GPP), long term evolution (LTE), LTE advanced (LTE-A), 4th generation (4G), 5th generation (5G), and the like, in addition to the communication manner described above.

A communication interface 160 including a circuit according to an embodiment of the present disclosure may perform communication with an external apparatus. For example, the communication interface 160 may receive various types of information related to a wireless power receiving apparatus 200 from an external apparatus (e.g., wireless power receiving apparatus), an external storage medium (e.g., USB memory), an external server (e.g., web hard), etc., through communication methods such as AP-based Wi-Fi (wireless LAN network), Bluetooth, Zigbee, a wired/wireless local area network (LAN), a wide area network (WAN), Ethernet, IEEE 1394, a high-definition multimedia interface (HDMI), a universal serial bus (UBS), a mobile high-definition link (MHL), an audio engineering society/European broadcasting union (AES/EBU), optical, and coaxial.

In addition, the communication interface 120 may include at least one of wired communication modules that perform communication using a local area network (LAN) module, an Ethernet module, a pair cable, a coaxial cable, an optical fiber cable, or an ultra wide-band (UWB) module, etc. In addition, the communication interface 120 may receive various types of information related to the wireless power receiving apparatus 200 from an external storage medium (e.g., a USB memory), an external server (e.g., a web hard drive), etc. Such a communication interface 120 may also be referred to as a transceiver.

According to one or more embodiments, the electronic apparatus 100 may receive a video through the communication interface 120. Here, the video may correspond to an original video file described above. Here, the video file may correspond to an image file in JPEG, PNG, GIF, or BMP formats.

At least one processor 140 may perform an overall control operation of the electronic apparatus 100.

The electronic apparatus 100 may display video data through the display 130. The display 140 may be implemented as a TV, but is not limited thereto, and any apparatus equipped with a display function, such as a video wall, a large format display (LFD), a digital signage, a digital information display (DID), and a projector display, may be applied without limitation.

In addition, the display 130 may be implemented in various types of displays such as a liquid crystal display (LCD), an organic light emitting diode (OLED), a liquid crystal on silicon (LCoS), a digital light processing (DLP), a quantum dot (QD) display panel, quantum dot light-emitting diodes (QLED), micro light-emitting diodes (μLED), a mini LED, and the like.

Meanwhile, the display 130 may be implemented as a touch screen coupled with a touch sensor, a flexible display, a rollable display, a 3D display, a display to which a plurality of display modules are physically connected, and the like. However, the display is not limited thereto, and the display 130 may also be implemented as the above-described E-paper.

At least one processor 140 may be implemented by a digital signal processor (DSP), a microprocessor, or a time controller (TCON) that processes a digital signal. However, the processor 410 is not limited thereto, but may include one or more of a central processing unit (CPU), a micro controller unit (MCU), a micro processing unit (MPU), a controller, an application processor (AP), a graphics-processing unit (GPU), a communication processor (CP), and an ARM processor, or may be defined by these terms. In addition, at least one processor 120 may be implemented by a system-on-chip (SoC) or a large scale integration (LSI) in which a processing algorithm is embedded, or may be implemented in a field programmable gate array (FPGA) form. In addition, at least one processor 140 may perform various functions by executing computer executable instructions stored in the memory. Meanwhile, FIG. 2 illustrates that the electronic apparatus 100 includes only one processor, but includes a plurality of processors (e.g., CPU + GPU, CPU + DSP) in implementation.

According to one or more embodiments, at least one processor 140 may segment a first video received through the communication interface 120 to acquire a plurality of sub-videos.

For example, at least one processor may be configured to acquire the plurality of sub-videos with the same size and resolution by segmenting the first video.

For example, at least one processor 140 may receive a video having a resolution of P x Q. Here, P may refer to the number of horizontal pixels included in the video. Here, Q may refer to the number of vertical pixels included in the video. In this case, the plurality of pixels included in the video may all have the same size.

In this case, at least one processor 140 may segment the first video into N sub-videos corresponding to the same size and resolution. Accordingly, at least one processor may acquire N sub-videos each having a resolution of P x (1/N) Q.

According to one or more embodiment, at least one processor 140 may perform gamut mapping on the first partial video data corresponding to the plurality of sub-videos to map the first partial video data to a second gamut different from a first gamut corresponding to the first video.

Here, the first partial video data may correspond to data acquired by decoding each of the plurality of sub-videos. Here, the decoding may refer to a process of decompressing the compressed original video to restore the original video data. At least one processor 140 may acquire data including visual information of the original video, such as pixel values, color information, and resolution of each frame, through the decoding.

For example, at least one processor 140 may perform the decoding on each of the plurality of sub-videos to acquire first partial video data including pixel values, color information, etc., of each of the plurality of sub-videos.

Here, the decoding performed on each of the plurality of sub-videos may be referred to as block decoding in the present disclosure.

Hereinafter, at least one processor 140 may perform the gamut mapping on the first partial video data.

Here, the gamut mapping may refer to a process of converting a color in a specific gamut into a color expressible in another gamut.

For example, when a specific color is not properly expressed in another apparatus or a color space due to a difference in gamut, the gamut mapping may refer to a process of corresponding a color to an approximate value as much as possible without distortion. The color space may correspond to a model (e.g., sRGB) that defines a range of colors expressible in a specific display or apparatus. In the present disclosure, the gamut and color space may be expressed with the same meaning.

The gamut mapping may mean a process of mapping from the first gamut to the second gamut.

Here, the first gamut may refer to a range of color space that is a starting point for converting colors in the gamut mapping. This gamut may correspond to a range of colors expressible in the specific electronic apparatus or color space.

For example, the first gamut may correspond to a gamut corresponding to the first video. Here, the first gamut may be a range of colors that the received original video may express, and may refer to the color space that is a reference before conversion in the gamut mapping.

Meanwhile, the second gamut may refer to a range of a target color space to which the converted colors arrive in the gamut mapping. Here, the second gamut may be a gamut in which colors converted from the first gamut are expressed, and a color expression range may be wider or narrower than that of the first gamut.

For example, the second gamut may refer to a color range of the target color space to which the color of the original video (the first gamut) is to be converted and matched, and may refer to the target color space in which the image will be expressed after the gamut mapping.

Meanwhile, the second gamut may refer to a range of colors that the E-paper may express. Due to its characteristics, the E-paper may display a video in limited colors or grayscale. Here, since the E-paper has low power and low resolution characteristics, the range of color expression may be narrow. In this case, at least one processor 140 may map the color of the original image to the second gamut by considering the color limitations of the E-paper.

According to one or more embodiments, at least one processor 140 may acquire the second video data having a size less than a size of the first partial video data.

Here, the data size is a value indicating the capacity of the stored data and may be measured in units of bytes. Here, regarding the data size, the total size of the first partial video data, may be the same as the size of the data acquired when the original video is decoded at once without being segmented. This will be described in detail with reference to FIG. 7.

.Meanwhile, at least one processor 140 may perform the gamut mapping on the plurality of partial videos to acquire the second video data.

For example, at least one processor 140 may perform the gamut mapping on the first partial video data corresponding to the plurality of sub-videos to acquire the second partial video data.

For example, at least one processor 140 may sequentially perform two operations (decoding and gamut mapping) on the plurality of sub-videos. At least one processor 140 may acquire the second partial video data for a sub-video on which both the decoding and gamut mapping have been performed among the plurality of sub-videos.

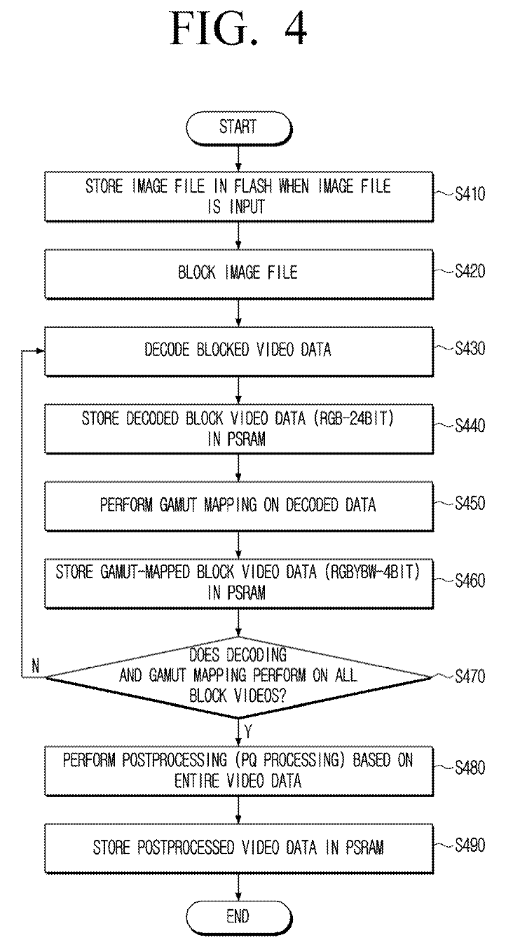

At least one processor 140 may acquire the second partial video data corresponding to the plurality of sub-videos when the decoding and gamut mapping are performed on all of the plurality of sub-videos. Accordingly, at least one processor 140 may stop the decoding and gamut mapping operation. This will be described in detail with reference to FIG. 4.

Meanwhile, a second color depth of the second gamut may be lower than a first color depth of the first gamut, for a plurality of pixels in the plurality of sub-videos. At least one processor 140 may perform the gamut mapping on the plurality of pixels based on the second color depth.

Here, the color depth may refer to granularity of colors that may be expressed in each gamut. Here, the color depth may be expressed as a number of bits that determines the number of colors that may be expressed per pixel in a video or a display.

Here, the higher the number of bits, the more colors may be expressed. Here, the bit may be expressed in a binary form.

Here, the first color depth may refer to the granularity of colors that may be expressed in the first gamut. For example, 167,000,000 colors may be displayed in a 24-bit RGB (or RGB-24bit) color space. However, the present disclosure is not limited thereto.

Meanwhile, the second color depth may refer to the granularity of colors that may be expressed in the second gamut.

For example, in an apparatus such as the E-paper, depending on the color display performance, only black and white or 4-level grayscale may be expressed with a 1-bit or 2-bit depth. However, the present disclosure is not limited thereto.

Meanwhile, the first partial video data may include a value according to the first gamut. For example, the first gamut may be implemented as a gamut according to RGB-24bit.

In this case, the first color depth corresponding to the first gamut may include, for the plurality of pixels, first color values including red (R), green (G), and blue (B) values. In this case, the first color values may respectively include a first number a number of bits corresponding to the first color depth. In this case, each of the R, G, and B values may include 8 bits, for example.

Here, the R value refers to the intensity of a red channel of the pixel, the G value refers to the intensity of a green channel, and the B value refers to the intensity of a blue channel, and each value may represent the brightness or intensity of the colors. Here, each channel may correspond to a component that independently stores the intensity values of specific color components (R, G, B, etc.) in each pixel of the video.

Accordingly, the first partial video data may include 24 bits for each of the plurality of pixels. In this case, each pixel may express 167,000,000 colors.

Meanwhile, at least one processor 140 may acquire the second partial video data including second color values of the second partial video data respectively including a second number of bits corresponding to a second color depth of the second gamut, the second number of bits being less than the first number of bits.

For example, when the first gamut is implemented as RGB-24bit, the second partial video data may include a smaller number of bits (less than 24) than the total sum (24) of the number of bits (each 8) included in each of the R, G, and B values.

For example, the second color values may include, for the plurality of pixels, each of the R, G, B, yellow (Y), black (B), and white (W) values. In this case, the second gamut may be implemented as RGBYBW-4bit.

The RGBYBW-4bit may correspond to a gamut that expresses only six colors of red (R), green (G), blue (B), yellow (Y), black (B), and white (W) with 4 bits. In this case, each pixel is expressed with 4 bits, and a total of 16 color combinations may express limited colors.

However, the present disclosure is not limited thereto, and even if the second gamut is implemented with RGBYBW-4bit, the second partial video data may include only R, yellow (Y), B, white (W) values among R, G, B, yellow (Y), B, and white (W) for each of the plurality of pixels. In addition, each pixel may express only six colors through the R, Y, B, W values.

Meanwhile, at least one processor 140 may sequentially perform the gamut mapping based on spatial locations of the plurality of sub-videos for the first partial video data corresponding to the plurality of sub-videos.

For example, when the first video is segmented into 8 sub-videos horizontally, the decoding and gamut mapping may be performed in the order of the topmost sub-video to the bottommost sub-video.

However, the present disclosure is not limited thereto, and the order in which each sub-video is processed (decoding and gamut mapping, etc.) may be the opposite of the above-described example, and may correspond to the order from the sub-video that starts from any sub-video up or down (left or right when the original video is segmented vertically).

Thereafter, at least one processor 140 may acquire the second video data based on the acquired second partial video data. Here, the second video data may correspond to data synthesized from the second partial video data. In this case, the second video data may correspond to data synthesized based on the spatial locations.

Here, the process of synthesizing the second partial video data may also be called image stitching. Here, the image stitching may refer to a process of combining a plurality of partial videos to generate one continuous video.

Thereafter, at least one processor 140 may perform the post-processing process based on the acquired second video data. Here, the post-processing process may include a process of improving the image quality of the video corresponding to the second video data.

Here, the process of improving the image quality of the video may refer to a task of improving the visual quality of the video through noise removal, resolution improvement, color correction, etc. For example, the process of improving the image quality of the video may include a process of applying a sharpening filter to make a blurred image clear. However, the present disclosure is not limited thereto.

Meanwhile, the post-processing process may correspond to a process of acquiring third video data. Here, the third video data may correspond to video data acquired through the post-processing process, which is ready to be output through an external display, etc., after the post-processing including image quality improvement, color correction, etc., is performed.

In this case, the size of the third video data may be less than the size (data size) of the first partial video data corresponding to the plurality of sub-videos. Here, the total size of the first partial video data may be the same as the size of the data acquired when the original video is not segmented and decoded at once. This will be described in detail with reference to FIG. 7.

According to one or more embodiments, at least one processor 140 may control the display 130 to display the second video corresponding to the first video based on the second video data.

Here, the second video corresponding to the first video may refer to a video converted to a different gamut than the first video. For example, the different gamut may refer to the second gamut described above. That is, at least one processor 140 may control the display 130 to convert the first video into a new gamut and display the second video.

Here, at least one processor 140 may control the display 130 to display the video based on the second video data. For example, the display 130 may be controlled to display the video corresponding to the second video data.

Here, the video corresponding to the second video data may refer to a video according to the pixel value and color information included in the video data. That is, the video corresponding to the second video data may refer to a video (e.g., a low-resolution video) converted from the first video (original video) to be adapted for the E-paper performance.

Meanwhile, at least one processor 140 may control the display 130 to display the video on which the post-processing process has been performed based on the second video data.

According to an embodiment, at least one processor 140 may control the display 140 to display the third video corresponding to the third video data. Here, the third video may correspond to a second video based on decoding, gamut mapping, and post-processing on the first video.

For example, at least one processor 140 may control the display 130 to display a video with improved image quality compared to the video corresponding to the second video data after performing the gamut mapping on the first video with a new gamut. However, the present disclosure is not limited thereto.

Meanwhile, at least one processor 140 may operate in either a block mode or a full mode.

Here, the block mode may correspond to a mode for segmenting the first video into multiple parts and processing the video (decoding, gamut mapping, etc.). At least one processor 140 may acquire the plurality of sub-videos during the block mode and perform the gamut mapping on the first partial video data corresponding to each of the plurality of sub-videos.

Meanwhile, the full mode may correspond to a mode for processing the input video (original video) at once.

At least one processor 140 may receive a user manipulation input, through the communication interface 120, for switching from the block mode to the full mode.

In this case, at least one processor 140 may, based on the user manipulation input being received, acquire fourth video data by decoding the first video. Here, the fourth video data may correspond to data acquired by performing the decoding on the video.

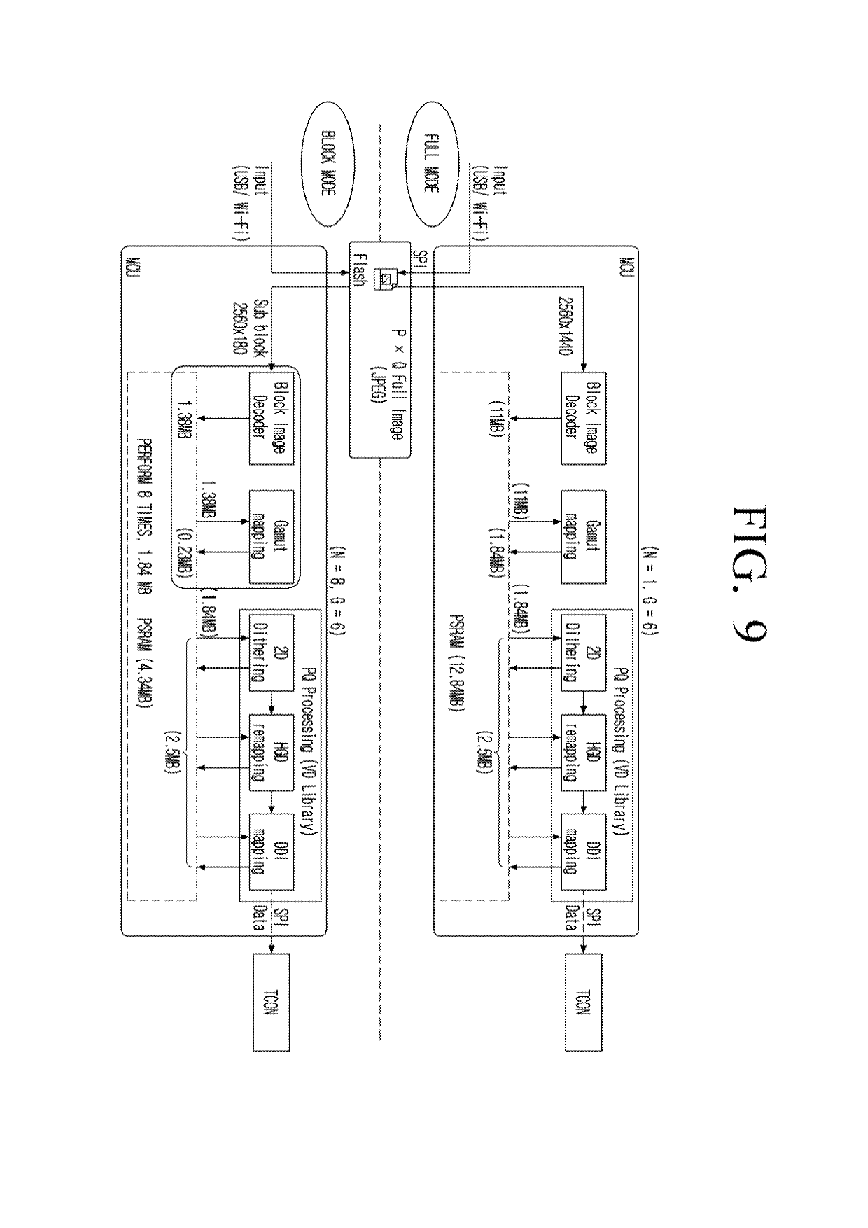

At least one processor may perform the gamut mapping on the fourth video data. This will be described in detail with reference to FIG. 9.

In FIG. 2, the electronic apparatus 100 is illustrated as including only the basic configuration (i.e., memory, communication interface, processor), but the electronic apparatus 100 may further include various configurations in addition to the configurations described above.

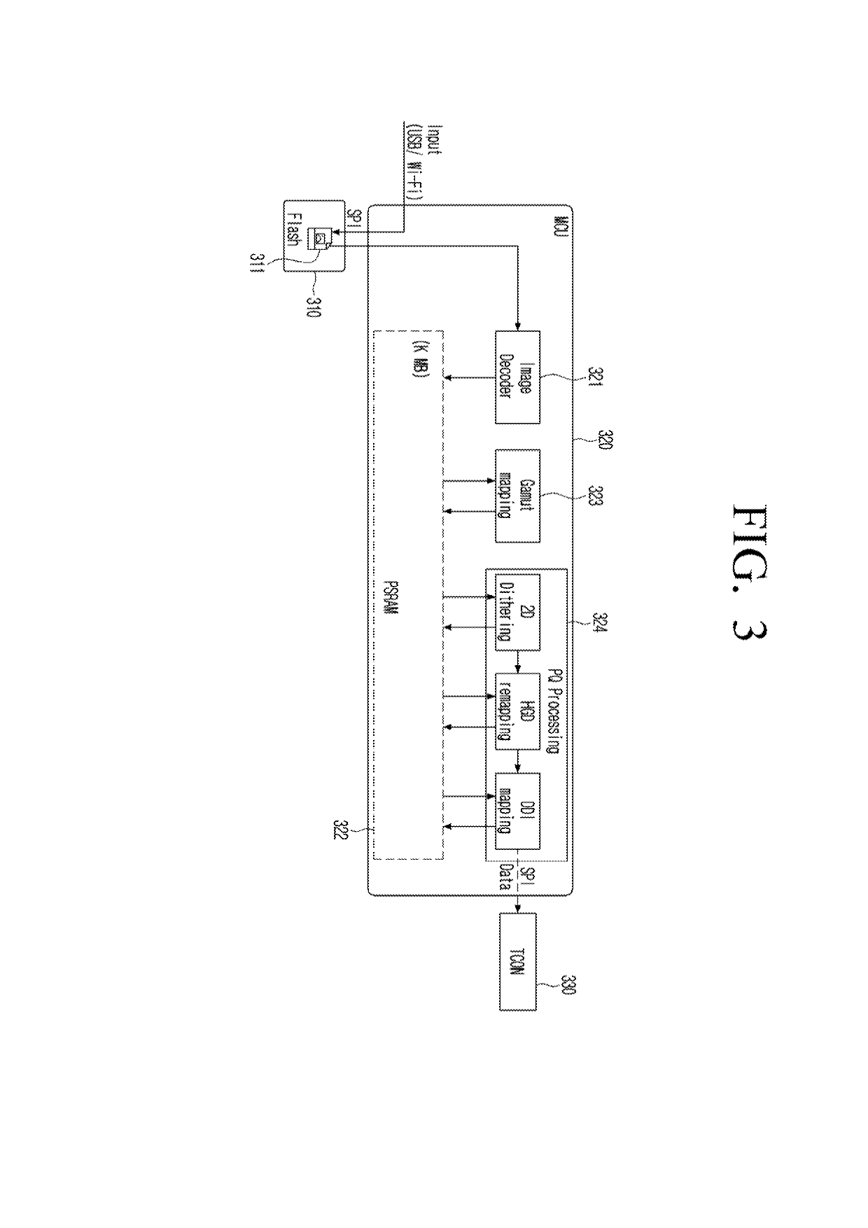

FIG. 3 is a diagram for describing a detailed configuration of the electronic apparatus according to one or more embodiments of the present disclosure.

Referring to FIG. 3, the electronic apparatus 100 may include an MCU 320, a flash 310, and a TCON 330.

The flash 310 may store an input video (video file) 311. Here, the video may correspond to a video received via a wired communication method such as USB or a wireless communication method such as Wi-Fi.

The microcontroller unit (MCU) 320 may process the video data of the input video. Here, the MCU is a processor that may be used in an embedded system, and may correspond to a small processor in which a CPU, a memory, and an input/output apparatus are integrated into one chip.

The MCU 320 may include an image decoder block 321 that decodes a video 311 input from the flash 310, a gamut mapping block 323, and a picture quality (PQ) processing block 324.

The MCU 320 may include a PSRAM 322. Here, the pseudo-static RAM (PSRAM) 322 may correspond to a memory that has a structure of DRAM but operates like SRAM externally. The PSRAM 322 requires periodic data update like the DRAM through a refresh circuit, but may be used like the SRAM when it is equipped in the MCU 320 as illustrated in FIG. 3. It may be used simply.

For example, while the MCU 320 performs a video processing process, the MCU 320 may store and temporarily process the image data through the PSRAM 322. For example, when the video file is large or has a high resolution, the internal memory of the MCU alone is not sufficient, so an additional storage space may be secured using the PSRAM 322.

Here, since the PSRAM 322 may process a large amount of data in a low-power state, it may be used to store intermediate data of the video or as temporary data storage during the operation process.

Accordingly, when the video processing process performed by the MCU 320 may be simplified or the size of the intermediate data may be reduced, the memory budget required for the PSRAM 322 may be reduced.

For example, the PSRAM 322 may temporarily store video data decoded and produced by the image decoder block 321. In addition, the gamut mapping block 323 may load video data from the PSRAM 322, perform the gamut mapping, and then temporarily store the video data acquired through the gamut mapping in the PSRAM 322.

Subsequently, the PQ processing block 324 may load data on which the gamut mapping has been completed from the PSRAM 322 and perform the postprocessing.

Here, the postprocessing may include the above-described 2D dithering, HGD remapping, and DDI mapping processes.

The MCU 320 may perform the postprocessing to acquire the final video. Based on this final video, the MCU 320 may provide SPI data to the timing controller (TCON) 330. Here, the serial peripheral interface (SPI) may correspond to a communication protocol that serially transmits data at high speed between a master apparatus and a slave apparatus. For example, the SPI may transmit and receive synchronized data using a clock signal.

The SPI data is serial data transmitted through the SPI protocol, and may correspond to commands, control signals, or actual data between the master and slave. Here, the SPI data may correspond to a signal for displaying the final video on the screen. In other words, the SPI data may correspond to serial data transmitted to the TCON 330, including video data that has undergone the preprocessing and postprocessing.

The TCON 330 may correspond to an apparatus that controls a timing signal of a display panel (e.g., an LED module) to display video data at an accurate time. For example, the TCON 330 may receive the SPI data and transmit color and timing information for each pixel of the display panel.

The TCON 330 may operate as an apparatus equipped in the electronic apparatus 100, but is not limited thereto. The TCON 330 may be located outside the electronic apparatus 100 to control the electronic apparatus 100 to receive the control signal (e.g., SPI data) and display a video on the display panel, etc.

The above-described configurations are only examples, and the electronic apparatus 100 may be implemented with various configurations necessary to process the original video and acquire the final video data.

FIG. 4 is a flowchart for describing the detailed configuration of the electronic apparatus according to one or more embodiments of the present disclosure.

Referring to FIG. 4, the electronic apparatus 100 processes video data included in an image file after the image file is input, and acquires video data for the final video.

The electronic apparatus 100 may store the input image file in the flash (S410). Thereafter, the electronic apparatus 100 may block the input image file (S420). Here, blocking may refer to segmenting the input video into multiple pieces to acquire the plurality of sub-videos.

Subsequently, the electronic apparatus 100 may decode the blocked video data (S430). The electronic apparatus 100 may store the decoded block video data in the PSRAM (S440). Here, the block video data may correspond to the first partial video data described above.

Here, the block video data may correspond to data based on the RGB-24bit color space. For example, the block video data may include a total of 24 bits for each of plurality of pixels.

Subsequently, the electronic apparatus 100 may perform the gamut mapping on the decoded data (S450). Subsequently, the electronic apparatus 100 may store the block video data on which the gamut mapping has been performed in the PSRAM (S460). Here, the block video data on which the gamut mapping has been performed may correspond to the second partial video data described above.

Here, the block video data on which the gamut mapping has been performed may correspond to data based on the RGBYBW-4bit color space. For example, the block video data on which the gamut mapping has been performed may include a total of 4 bits for each of plurality of pixels.

Next, the electronic apparatus 100 may identify whether the decoding and gamut mapping have been performed on all of the block videos (S470). When it is identified that the decoding and gamut mapping have not been performed on all of the block videos, the electronic apparatus 100 may re-perform operations (S430 to S460) from an operation of decoding the blocked video data (S430) to an operation of storing the block video data on which the gamut mapping has been performed in the PSRAM (S460).

When it is identified that the decoding and gamut mapping are not performed on all block videos, the electronic apparatus 100 may perform the postprocessing based on the entire video data (S480).

Here, the entire video data may correspond to the second video data described above. For example, the entire video data may correspond to data synthesized from multiple block video data on which the gamut mapping is performed.

That is, the electronic apparatus 100 may repeatedly perform the decoding and gamut mapping until the decoding and gamut mapping are performed on all the blocked video data. Here, for the multiple blocked videos, the decoding and gamut mapping may be performed in order according to the spatial locations of each of the blocked videos.

Subsequently, the electronic apparatus 100 may store the postprocessed video data in the PSRAM (S490).

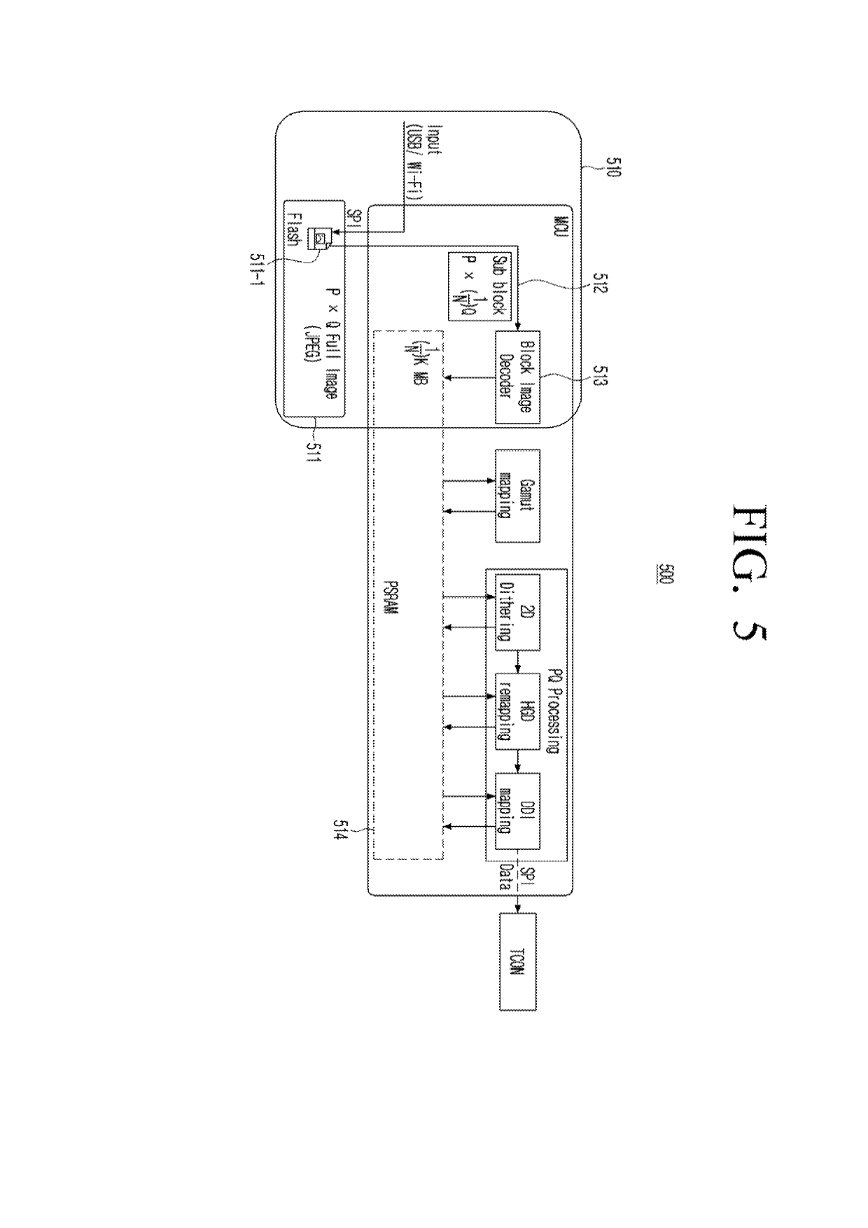

FIG. 5 is a diagram for describing a block decoding operation according to one or more embodiments of the present disclosure.

Referring to FIG. 5, the electronic apparatus 100 may perform a block decoding process 510.

The electronic apparatus 100 may receive an original video (original video file) 511-1 and store the original video in a flash 511. Here, the original video may correspond to a video of PxQ resolution.

The electronic apparatus 100 may segment the original video into N pieces. For example, the electronic apparatus 100 may divide the original video into N pieces vertically. In this case, the electronic apparatus 100 may acquire N sub-videos of Px(1/N)Q resolution.

In this case, the electronic apparatus 100 may segment the original video into N sub-videos using header information among the video data included in the original video.

For example, the electronic apparatus 100 may read the resolution, frame count, color information, etc., from the header and identify a starting point of each section (sub-video). The electronic apparatus 100 may separately extract and segment data blocks included in the original video based on the starting point.

Here, the generated sub-video may be called a sub-block 512. The electronic apparatus 100 may sequentially decode a plurality of sub-blocks 512 from the first to the Nth through the MCU. Here, the decoding may be performed by a block image decoder 513.

However, the electronic apparatus 100 may decode the next sub-block after the decoded sub-block 512 is subjected to the gamut mapping, rather than decoding the next sub-block immediately after the sub-block 512 is decoded.

The electronic apparatus 100 may acquire the first partial video data having a size of (1/N)K MB after decoding the sub-block 512. Here, K may correspond to the size of the video data that may be acquired when the electronic apparatus 100 decodes the entire original video 511-1. That is, K may correspond to the size of the decoded video data of the original video 511-1.

Here, the size may refer to the data size. The data size is a value indicating the capacity of the stored data and may be measured in units of bytes.

The electronic apparatus 100 may perform the gamut mapping, which is the next step, on the acquired first partial video data of (1/N)K MB size.

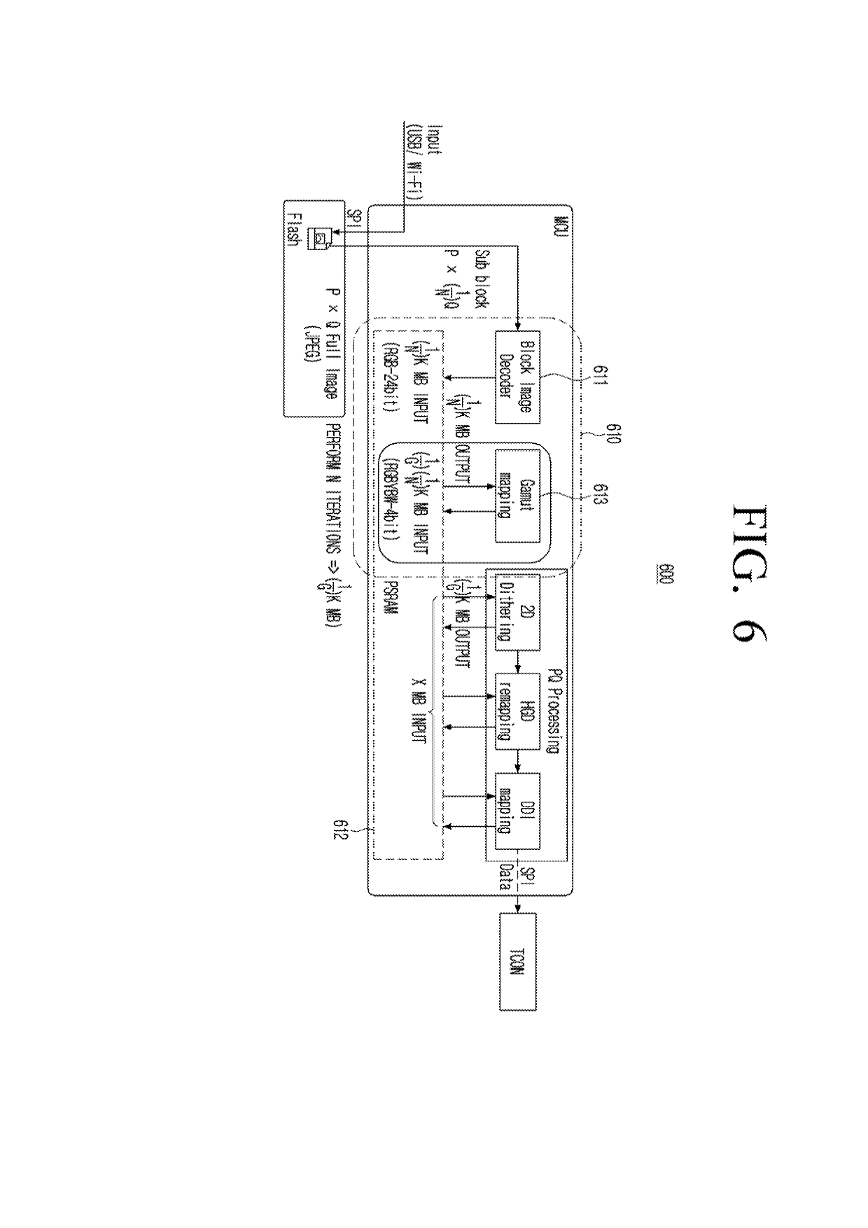

FIG. 6 is a diagram for describing gamut mapping according to one or more embodiments of the present disclosure.

Referring to FIG. 6, the electronic apparatus 100 may perform a gamut mapping process 610.

The electronic apparatus 100 may store the first partial video data acquired through a block image decoder block 611 in the PSRAM 612, load the first partial video data from a PSRAM 612, and perform the gamut mapping through a gamut mapping block 613.

Here, the gamut mapping block 613 loads the first partial video data ((1/N)K MB) from the PSRAM 612, so that the first partial video data ((1/N)K MB) may be output from the PSRAM 612.

Here, the first partial video data may correspond to the decoded data of the first block among the plurality of sub-blocks. However, the present disclosure is not limited thereto, and after the gamut mapping is performed on the first sub-block, the sub-block that is decoded later among the plurality of sub-blocks may correspond to the decoded data.

In this case, the first partial video data may have a size of (1/N)K MB. The first partial video data may correspond to data based on a RGB-24bit color space.

The gamut mapping block 613 may acquire the first partial video data from the PSRAM 612. The gamut mapping block 613 may perform the gamut mapping on the first partial video data to acquire the second partial video data.

In this case, the second partial video data may correspond to data of (1/G)(1/N)K MB size. The second partial video data may correspond to data based on a RGBYBW-4bit color space.

That is, the second partial video data may correspond to data having a size (1/G) times the size of the first partial video data. Here, G may correspond to a parameter indicating how the size of the entire data changes when the bit depth is reduced during the gamut mapping from the first gamut (e.g., RGB-24bit) to the second gamut (e.g., RGBYBW-4bit). Here, the bit depth may correspond to the same meaning as the color depth described above.

For example, when mapping the gamut from RGB-24bit to RGBYBW-4bit, the size of the second partial video data may be reduced to 1/6 of the size of the first partial video data. In this case, the G value may correspond to 6. =

Accordingly, the electronic apparatus 100 may perform the gamut mapping on the first partial video data ((1/N)K MB) acquired by decoding the first sub-block. When the gamut mapping corresponding to the first sub-block is all performed, the second partial video data of (1/G)(1/N)K MB size may be stored in the PSRAM 612.

Subsequently, the electronic apparatus 100 may perform the decoding and gamut mapping on the next sub-block in the same manner as the first sub-block to acquire the second partial video data of (1/G)(1/N)K MB size and store the second partial video data in the PSRAM612.

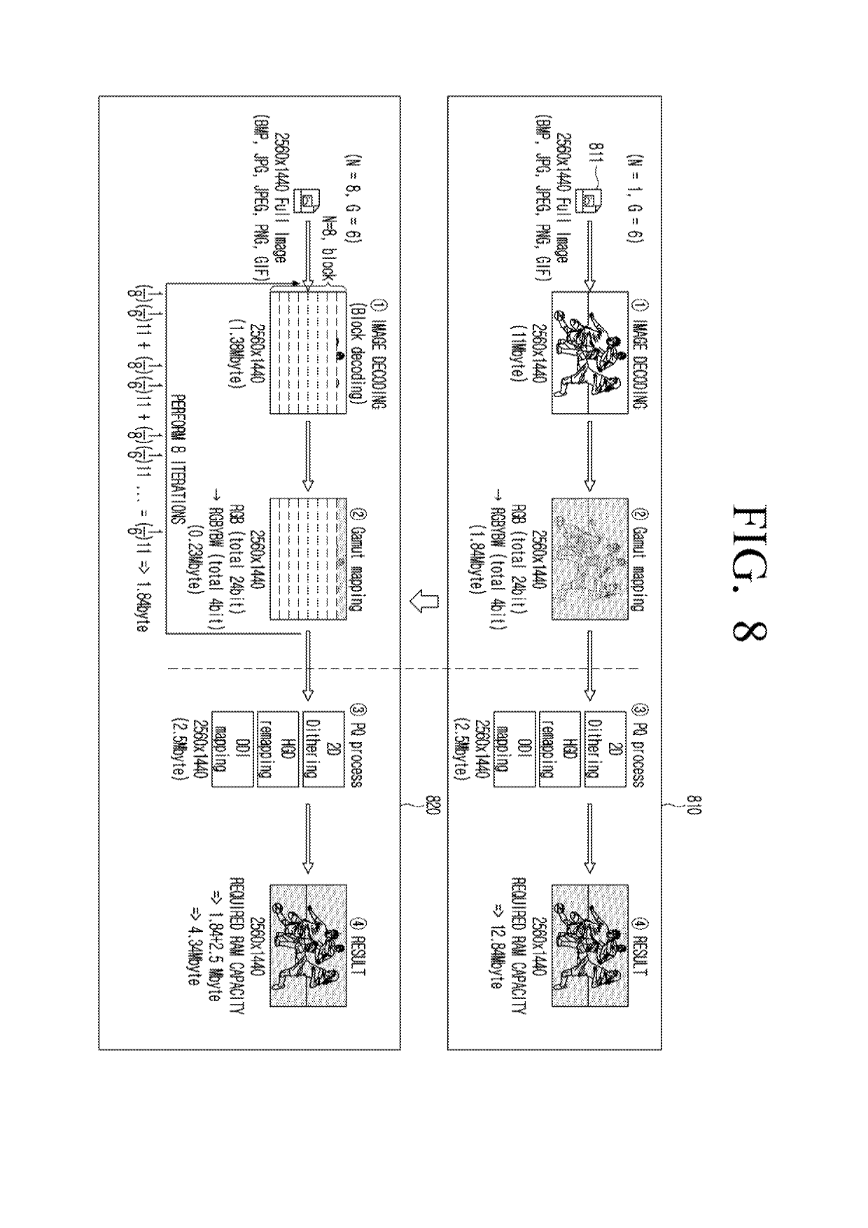

The electronic apparatus 100 may repeat this process (decoding and gamut mapping) N times for all sub-blocks (N sub-blocks). Accordingly, the second partial video data of (1/G)(1/N)K MB size may be stored in the PSRAM612 N times, so that the video data of (1/G) K MB size may be stored in the PSRAM. This will be described in detail with reference to FIG. 8.

In this case, the stored video data may correspond to the second video data. Based on the second video data, the electronic apparatus 100 may perform a subsequent process (postprocessing).

FIG. 7 is a diagram for describing a memory budget according to one or more embodiments of the present disclosure.

Referring to FIG. 7, a memory budget of a first method 710 for decoding an original video at once and a memory budget of a second method 720 for decoding (block decoding, block unit decoding) an original video by segmenting the original data are illustrated.

Here, the memory budget may refer to the storage space required for the PSRAM for the electronic apparatus 100 to process the input video (decoding, gamut mapping, postprocessing, etc.). That is, the memory budget may not refer to the capacity of the video data actually stored in the PSRAM, but the data capacity of the PSRAM expected to be required to perform the video processing process as described above.

Each of the first method 710 and the second method 720 includes a table showing the calculated data capacity and the PSRAM memory budget for each process of video processing. Here, the calculated data may correspond to the results generated in each video processing process (decoding, gamut mapping, and postprocessing).

Here, the capacity indicated in the PSRAM memory budget may refer to the memory capacity required to store the results according to the data size of the results generated in each process.

According to the first method 710, the electronic apparatus 100 may acquire K MB of video data through the image decoding. Accordingly, the PSRAM may require at least K MB of memory space.

Thereafter, through the gamut mapping, the electronic apparatus 100 may acquire (1/G)K MB of video data. In this case, the electronic apparatus 100 may perform the gamut mapping using K MB of video data stored in the PSRAM.

That is, since K MB of video data should be stored in the PSRAM until the gamut mapping is completely performed, K + (1/G)K MB of memory space may be required for the process up to the gamut mapping to be performed.

Thereafter, the electronic apparatus 100 may perform the postprocessing process based on (1/G)K MB of video data acquired through the gamut mapping. The electronic apparatus 100 may acquire X MB of final video data through the postprocessing process.

The electronic apparatus 100 may perform the postprocessing process by utilizing the K MB capacity that is not used because the decoding is already completed. Accordingly, even when the postprocessing process is performed after the gamut mapping, the memory budget may not increase.

When the gamut mapping is completely performed using the video data after the decoding, a free space of K MB size may be generated in the PSRAM. That is, when the gamut mapping is completely performed, the video data of K MB size that was temporarily stored for the gamut mapping may no longer exist in the PSRAM. In other words, utilizing the K MB capacity that is not used because the decoding is already completed may refer to utilizing this storage space.

On the other hand, according to the second method 720, the electronic apparatus 100 may acquire (1/N)K MB of video data through the block decoding. Accordingly, the PSRAM may require at least (1/N)K MB of memory space. Here, the video data acquired through the block decoding may correspond to the first partial video data described above.

Thereafter, through the gamut mapping on (1/N)K MB of video data, the electronic apparatus 100 may acquire (1/N)(1/G)K MB of video data. In this case, the electronic apparatus 100 may perform the gamut mapping using (1/N)K MB of video data stored in the PSRAM. Here, the video data acquired through the gamut mapping may correspond to the second partial video data described above.

That is, since (1/N)K MB of video data should be stored in the PSRAM until the gamut mapping is completely performed on the first sub-block, (1/N)K + (1/N) (1/G)K MB of memory space may be required to perform the process up to the gamut mapping on the first sub-block.

The electronic apparatus 100 may acquire (1/N)(1/G)K MB by performing the decoding and gamut mapping on the second sub-block. The electronic apparatus 100 may repeat this process N times to acquire (1/G)K MB of video data through the gamut mapping. Accordingly, (1/N)K + (1/G)K MB of memory space may be required until the gamut mapping is performed on all the sub-blocks.

Thereafter, the electronic apparatus 100 may perform the postprocessing process based on (1/G)K MB of video data acquired through the gamut mapping. The electronic apparatus 100 may acquire the final video data of X MB through the postprocessing process. Here, the final video data may correspond to the third video data described above.

In this case, the electronic apparatus 100 may perform the postprocessing process by utilizing the (1/N)K MB capacity that is not used because the decoding has already been completed. In this case, the size (X MB) of final video data acquired through the postprocessing process may be larger than the output data capacity (1/N)K MB after the block decoding. Accordingly, the memory budget required for the electronic apparatus 100 to perform the postprocessing process may correspond to X + (1/G)K MB.

When the gamut mapping is performed using the video data after the block decoding, (1/N)K MB of free space may be generated in the PSRAM. The electronic apparatus 100 utilizes the (1/N)K MB capacity that is not used because the block decoding is already completed, but acquires X MB of video data that is larger than (1/N)K through the postprocessing, so the memory budget required until the final stage may correspond to X + (1/G)K MB.

As described above, since X MB is less than K MB, which is the size of video data acquired by performing the decoding on the entire video, in the case of the second method, the entire memory budget may be reduced from K+ (1/G)K MB to X + (1/G)K MB.

FIG. 8 is a diagram for describing a memory budget according to one or more embodiments of the present disclosure.

FIG. 8 illustrates a process of calculating a memory budget according to each of a first method 810 and a second method 820 described in FIG. 7, using actual numbers as examples.

Here, the values given as examples of the capacity of the original video, the capacity of the decoded video data (K), N, and G (e.g., 11 Mbyte (MB), 1.84 Mbyte, 1, 6, etc.) are only examples, and it is obvious that other values may be applied instead.

According to the first method 810, since N is 1, the electronic apparatus 100 may decode the input video at once without segmenting the input video.

The electronic apparatus 100 may receive the original video with a resolution of 2560 × 1440 and decode the original video to acquire 11 MB of video data.

Subsequently, the electronic apparatus 100 may perform the gamut mapping on the acquired video data when G is 6 to acquire 1.84 MB of video data.

Here, 6 may correspond to the value of G when the color space corresponding to the first gamut is RGB-24bit and the color space corresponding to the second gamut is RGBYBW-4bit. In addition, 1.84 MB here may correspond to an approximate value of (1/G)K value obtained by dividing the capacity (K) 11 of the video data after the decoding by 6.

Thereafter, the electronic apparatus 100 may perform the postprocessing based on 1.84 MB of video data to acquire 2.5 MB of final video data. In this case, the electronic apparatus 100 may store the acquired final video data in the PSRAM by utilizing 11 MB of memory space that is not used after the decoding is completed.

Accordingly, when the electronic apparatus 100 processes video according to the first method 810, the memory budget may be 12.84 MB (K + (1/G)K MB) by adding 11 MB and 1.84 MB.

Meanwhile, according to the second method 820, since N is 8, the electronic apparatus 100 may segment the input video into 8.

That is, the electronic apparatus 100 may segment the original video with a resolution of 2560 × 1440 to acquire 8 sub-blocks with a resolution of 2560 × 180. The electronic apparatus 100 may acquire 1.38 MB of video data by decoding the first sub-block (the sub-block located at the top) with a resolution of 2560 × 180 among the 8 sub-blocks.

Subsequently, the electronic apparatus 100 may perform the gamut mapping on the acquired video data when G is 6 to acquire 0.23 MB of video data.

Here, as in the first method, when the color space corresponding to the first gamut is RGB-24bit and the color space corresponding to the second gamut is RGBYBW-4bit, G may correspond to 6. In addition, 0.23 MB may correspond to the (1/G)K value obtained by dividing the capacity (K) 1.38 of the video data after the decoding by 6.

The electronic apparatus 100 may perform the decoding and gamut mapping on the second sub-block to similarly acquire 0.23 MB ((1/N)(1/G)K MB) of video data. The electronic apparatus 100 may repeat this process 8 times to acquire 1.84 MB ((1/G)K MB) of video data. Accordingly, 3.22 MB of memory space may be required by adding 1.38 MB and 1.84 MB until the gamut mapping is performed on all the sub-blocks.

In this case, the electronic apparatus 100 may perform the postprocessing process by utilizing 1.38 MB ((1/N)K MB) capacity that is not used because the decoding has already been completed. In this case, 2.5 MB (X MB), which is the size of the final video data acquired through the postprocessing process, may be larger than 1.38 MB (1/N)K MB. Accordingly, the memory budget required for the electronic apparatus 100 to perform the postprocessing process may correspond to 4.34 MB (X + (1/G)K MB) by adding 1.84 MB and 2.5 MB.

As in this example, when the electronic apparatus 100 segments the input video instead of decoding the input video at once and performs the preprocessing process (decoding and gamut mapping) separately, the memory budget may be reduced from 12.84 MB to 4.34 MB, which decreases by 8.5 MB.

As the memory budget is reduced in this way, the capacity and quantity of required memory chips may be reduced. Accordingly, the raw materials and production process required for memory manufacturing may be simplified, and the memory production cost may be reduced.

FIG. 9 is a diagram for describing a block mode and a full mode according to one or more embodiments of the present disclosure.

Referring to FIG. 9, the electronic apparatus 100 may operate in either a full mode 910 or a block mode 920.

The data size (capacity) values illustrated in each of the full mode 910 and the block mode 920 may refer to the size of data input to the PSRAM or output from the PSRAM. Here, each data size value is described as an example value in FIGS. 7 and 8, but is not necessarily limited thereto.

In addition, the values of N and G illustrated in each of the full mode 910 and the block mode 920 are described as an example value in FIGS. 7 and 8, but are not necessarily limited thereto.

Here, the electronic apparatus 100 may operate in the full mode 910 or the block mode 920 based on the user manipulation input for selecting the mode.

Here, the electronic apparatus 100 may receive the user manipulation input through various operation interfaces such as a keyboard, a mouse, a manipulation button, and a touchable display provided in the electronic apparatus. However, the electronic apparatus 100 is not limited thereto.

The full mode 910 may correspond to a mode for processing the input video (original video) at once. The block mode 920 may correspond to a mode for segmenting the first video into multiple parts and processing the video (decoding, gamut mapping, etc.).

The electronic apparatus 100 may acquire video data by decoding the video received during the full mode 910. Here, the video data acquired through the decoding may correspond to the fourth video data described above.

The electronic apparatus 100 may perform the gamut mapping on the acquired video data. For implementation details of the operations for the full mode 910, reference may be made to the descriptions of other figures provided above, such as the descriptions of FIGS. 7 and 8, for example.

The electronic apparatus 100 may decode a plurality of sub-blocks during the block mode 910 to acquire video data corresponding to each of the plurality of sub-blocks. Here, the video data acquired by the decoding may correspond to the first partial video data described above.

The electronic apparatus 100 may perform the gamut mapping on the acquired video data and perform the same operation (decoding and gamut mapping) on the remaining sub-blocks.

For implementation details of the block mode 910, reference may be made to the descriptions above.

Meanwhile, the electronic apparatus 100 may operate by switching to the full mode 920 while operating in the block mode 920. In this case, the electronic apparatus 100 may switch to the block mode 910 based on the user manipulation input for switching from the block mode 920 to the full mode 910.

For example, the full mode 910 and the block mode 920 may have different memory budgets for each mode to be performed. In the case of FIG. 9, the memory budget for performing the full mode 910 may be 12.84 MB, and the memory budget for performing the block mode 920 may be 4.3 4 MB.

In this case, when the electronic apparatus 100 has a PSRAM with a capacity of 5 MB, the electronic apparatus 100 may not operate in the full mode 910 with a memory budget of 12.84 MB. However, when the electronic apparatus 100 has a PSRAM with a capacity of 13 MB, the electronic apparatus 100 may operate in both the full mode 910 and the block mode 920.

For example, the electronic apparatus 100 may operate in the block mode 920 with a low memory budget but a low video processing speed, and then switch to the full mode 910 with a high memory budget but a high video processing speed.

That is, the user may operate the electronic apparatus 100 so that it operates in the block mode 920, and then input an operation to switch the electronic apparatus 100 from the block mode 920 to the full mode 910 in some cases.

For example, when the user has sufficient a free space in the memory (PSRAM) and needs a fast video processing function, the user may input an operation to switch from the block mode 920 to the full mode 910.

However, the present disclosure is not limited thereto, and the electronic apparatus 100 may switch to the block mode 920 based on the user manipulation input while operating in the full mode 910.

Accordingly, the electronic apparatus 100 may operate in one of the full mode 910 and the block mode 920 depending on whether there is a memory space constraint, instead of operating in a fixed mode. Through this, the electronic apparatus 100 may operate in an appropriate mode depending on the state of the free space in the memory or the user’s request.

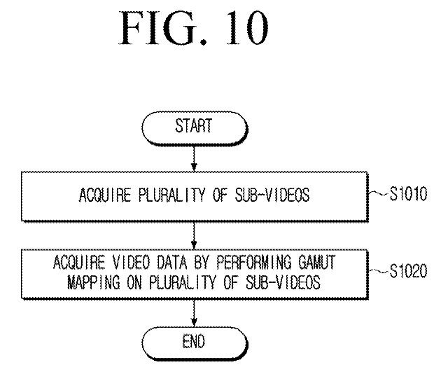

FIG. 10 is a flowchart for describing a control method of an electronic apparatus according to one or more embodiments of the present disclosure.

The electronic apparatus 100 may acquire the plurality of sub-videos (S1010).

According to one or more embodiments, the electronic apparatus 100 may acquire the plurality of sub-videos by segmenting the first video.

According to one or more embodiments, the electronic apparatus 100 may acquire the plurality of sub-videos having the same size and resolution by segmenting the first video.

Subsequently, the electronic apparatus 100 may acquire the second video data by performing the gamut mapping on each of the plurality of sub-videos (S1020).

According to one or more embodiments, the electronic apparatus 100 may acquire the first partial video data corresponding to each of the plurality of sub-videos.

For example, the electronic apparatus 100 may acquire the first partial video data by decoding each of the plurality of sub-videos.

According to one or more embodiments, the electronic apparatus 100 may perform the gamut mapping on the first partial video data to map the first partial video data to the second gamut that is different from the first gamut corresponding to the first video.

For example, the electronic apparatus 100 may perform the gamut mapping on each of the plurality of pixels based on the second color depth lower than the first color depth corresponding to the first gamut.

According to one or more embodiments, the electronic apparatus 100 may acquire second partial video data by performing gamut mapping on the first partial video data, and to acquire the second video data based on the second partial video data.

Through this, the electronic apparatus 100 may maintain the same video processing process including the decoding, the gamut mapping, and the postprocessing, but may process the video by block by segmenting the original video into blocks.

When the electronic apparatus 100 processes the video in this manner, the memory space required for video processing may be reduced compared to a method of processing an entire video at once. Accordingly, the memory budget that should be secured for video processing may be reduced.

Accordingly, the capacity and quantity of memory chips required for manufacturing the electronic apparatus 100 may be reduced, and the raw materials and production process required for memory manufacturing may be simplified. Therefore, there is an effect of lowering the manufacturing cost by reducing the production cost of the memory semiconductor and the cost of memory-related components in an apparatus. In particular, when the electronic apparatus 100 is implemented as an apparatus for displaying video on E-paper, the electronic apparatus 100 may be designed to be more suitable for the characteristics of E-paper that mainly expresses low resolution and simple colors (black and white, limited color expression).

Meanwhile, in FIG. 10, the order is mapped for all steps for convenience of description, but it is obvious that the order of steps that are not related to the order or may be performed in parallel is not necessarily limited to the corresponding order.

Meanwhile, methods according to at least some of the various embodiments of the present disclosure described above may be implemented in the form of applications that may be installed on existing electronic apparatuses.

Additionally, the methods according to at least some of the various embodiments of the present disclosure described above may be implemented only with a software upgrade or a hardware upgrade for an existing electronic apparatus.

Additionally, the methods according to at least some of the various embodiments of the present disclosure described above may also be performed via an embedded server provided in the electronic apparatus, or an external server of at least one of the electronic apparatuses.

Meanwhile, according to an embodiment of the disclosure, various embodiments described above may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus A) according to the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the ‘non-transitory storage medium’ means that the storage medium is a tangible apparatus, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored. According to an exemplary embodiment, the methods according to the diverse exemplary embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play StoreTM) or may be directly distributed (for example, download or upload) between two user apparatuses (for example, smartphones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

Various embodiments of the present disclosure may be implemented by software including instructions stored in a machine-readable storage medium (for example, a computer-readable storage medium). A machine may be an apparatus that invokes the stored instruction from the storage medium and may be operated depending on the invoked instruction, and may include the electronic apparatus (for example, the electronic apparatus A) according to the disclosed embodiments.

In the case in which the above-described command is executed by the processor, the processor may directly perform a function corresponding to the command or other components may perform the function corresponding to the command under a control of the processor. The command may include codes created or executed by a compiler or an interpreter.

Although exemplary embodiments of the present disclosure have been illustrated and described hereinabove, the present disclosure is not limited to the abovementioned specific exemplary embodiments, but may be variously modified by those skilled in the art to which the present disclosure pertains without departing from the gist of the present disclosure as disclosed in the accompanying claims. These modifications should also be understood to fall within the scope and spirit of the present disclosure.

1. An electronic apparatus, comprising:
memory storing at least one instruction;
a communication interface;
a display; and
at least one processor,
wherein the at least one instruction, when executed by the at least one processor, individually or collectively, causes the electronic apparatus to:
acquire a plurality of sub-videos by segmenting a first video received through the communication interface,
acquire second video data by performing gamut mapping on first partial video data corresponding to the plurality of sub-videos to map the first partial video data to a second gamut different from a first gamut corresponding to the first video, wherein a size of the second video data is less than a size of the first partial video data, and
control the display to display a second video corresponding to the first video based on the second video data.

2. The electronic apparatus as claimed in claim 1, wherein the at least one instruction, when executed by the at least one processor, individually or collectively, causes the electronic apparatus to acquire the plurality of sub-videos by segmenting the first video such that the plurality of sub-videos have a same size and a same resolution.

3. The electronic apparatus as claimed in claim 1, wherein the at least one instruction, when executed by the at least one processor, individually or collectively, causes the electronic apparatus to acquire second partial video data by performing gamut mapping on the first partial video data, and to acquire the second video data based on the second partial video data.

4. The electronic apparatus as claimed in claim 3, wherein the at least one instruction, when executed by the at least one processor, individually or collectively, causes the electronic apparatus to acquire the first partial video data by decoding the plurality of sub-videos, and to acquire the second partial video data by performing gamut mapping on the first partial video data.

5. The electronic apparatus as claimed in claim 4, wherein a second color depth of the second gamut is lower than a first color depth of the first gamut, for a plurality of pixels in the plurality of sub-videos.

6. The electronic apparatus as claimed in claim 5, wherein the first partial video data comprises, for the plurality of pixels, a first plurality of color values comprising red (R), green (G), blue (B) values,
wherein the first plurality of color values respectively comprise a first number of bits corresponding to the first color depth, and
wherein a second plurality of color values of the second partial video data respectively comprise a second number of bits corresponding to the second color depth, the second number of bits being less than the first number of bits.

7. The electronic apparatus as claimed in claim 6, wherein the first plurality of color values respectively comprise 8 bits,
wherein the second plurality of color values comprise, for the plurality of pixels, R, yellow (Y), B, and white (W) values, and
wherein the second gamut comprises 6 colors, the 6 colors being based on the R, Y, B, and W values.

8. The electronic apparatus as claimed in claim 1, wherein the at least one instruction, when executed by the at least one processor, individually or collectively, causes the electronic apparatus to sequentially perform gamut mapping on the first partial video data based on spatial locations of the plurality of sub-videos.

9. The electronic apparatus as claimed in claim 1, wherein the at least one instruction, when executed by the at least one processor, individually or collectively, causes the electronic apparatus to acquire, based on postprocessing the second video data for improved image quality, third video data having a size less than the size of the first partial video data, and
control the display to display a third video corresponding to the third video data.

10. The electronic apparatus as claimed in claim 1, wherein the at least one instruction, when executed by the at least one processor, individually or collectively, causes the electronic apparatus to:
acquire the second video data by performing gamut mapping on the first partial video data based on a block mode in which the first video is segmented into a plurality of pieces, and
receive a user manipulation input, through the communication interface, for switching from the block mode to a full mode,
based on the user manipulation input being received, acquire fourth video data by decoding the first video, and acquire the second video data by performing gamut mapping on the fourth video data.

11. A control method of an electronic apparatus, comprising:
acquiring a plurality of sub-videos by segmenting a first video received through a communication interface;
acquiring second video data by performing gamut mapping on first partial video data corresponding to the plurality of sub-videos to map the first partial video data to a second gamut different from a first gamut corresponding to the first video, wherein a size of the second video data is less than a size of the first partial video data; and
displaying a second video corresponding to the first video based on the second video data.

12. The control method as claimed in claim 11, wherein the acquiring the plurality of sub-videos comprises acquiring the plurality of sub-videos by segmenting the first video such that the plurality of sub-videos have a same size and a same resolution.

13. The control method as claimed in claim 11, wherein the acquiring the second video data comprises acquiring second partial video data by performing gamut mapping on the first partial video data, and acquiring the second video data based on the second partial video data.

14. The control method as claimed in claim 13, wherein the acquiring the second partial video data comprises acquiring the first partial video data by decoding the plurality of sub-videos, and acquiring the second partial video data by performing gamut mapping on the first partial video data.

15. The control method as claimed in claim 14, wherein a second color depth of the second gamut is lower than a first color depth of the first gamut, for a plurality of pixels in the plurality of sub-videos.

16. The control method as claimed in claim 15, wherein the first partial video data comprises, for the plurality of pixels, a first plurality of color values comprising red (R), green (G), blue (B) values,
wherein the first plurality of color values respectively comprise a first number of bits corresponding to the first color depth, and
wherein a second plurality of color values of the second partial video data respectively comprise a second number of bits corresponding to the second color depth, the second number of bits being less than the first number of bits.

17. The control method as claimed in claim 16, wherein the first plurality of color values respectively comprise 8 bits,
wherein the second plurality of color values comprise, for the plurality of pixels, R, yellow (Y), B, and white (W) values, and
wherein the second gamut comprises 6 colors, the 6 colors being based on the R, Y, B, and W values.

18. The control method as claimed in claim 11, wherein the performing the gamut mapping comprises sequentially performing gamut mapping on the first partial video data based on spatial locations of the plurality of sub-videos.

19. The control method as claimed in claim 11, further comprising:
acquiring, based on postprocessing the second video data for improved image quality, third video data having a size less than the size of the first partial video data; and
displaying a third video corresponding to the third video data.

20. A non-transitory computer-readable storage medium having at least one instruction recorded thereon, that, when executed by at least one processor, individually or collectively, cause the at least one processor to:
acquire a plurality of sub-videos by segmenting a first video received through a communication interface;
acquire second video data by performing gamut mapping on first partial video data corresponding to the plurality of sub-videos to map the first partial video data to a second gamut different from a first gamut corresponding to the first video, wherein a size of the second video data is less than a size of the first partial video data; and
display a second video corresponding to the first video based on the second video data.
